(19) United States
(12) Patent Application Publication
(10) Pub. No.: US 2010/0084262 A1
(43) Pub. Date: Apr. 8, 2010

(54) MANUFACTURING METHOD OF PERPENDICULAR MAGNETIC RECORDING HEAD

(75) Inventors: Hiromichi Umehara, Tokyo (JP); Shin Narushima, Tokyo (JP); Michitaka Nishiyama, Tokyo (JP); Noriaki Kasahara, Tokyo (JP); Koichi Otani, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: TDK CORPORATION, Tokyo (JP)

(21) Appl. No.: 12/244,298

(22) Filed: Oct. 2, 2008

(51) Int. Cl. G11B 5/33

(52) U.S. Cl. 204/192.34

(57) ABSTRACT

The present invention relates to a method for manufacturing a perpendicular recording magnetic head. The method for manufacturing a perpendicular recording magnetic head according to the present invention includes first to third steps. At the first step, a main magnetic pole layer is formed on a foundation layer. At the second step, a main magnetic pole forming mask whose recording-medium-facing surface is of an inverted trapezoidal shape is formed on the main magnetic pole layer. At the third step, a main magnetic pole whose recording-medium-facing surface is of an inverted trapezoidal shape is formed by performing ion milling on a laminated structure including the foundation layer and the main magnetic pole layer from a direction which makes a given angle with a lamination direction according to a bevel angle of the inverted trapezoidal shape.

### TECHNICAL FIELD

The present invention relates to a method for manufacturing a perpendicular recording magnetic head.

### BACKGROUND OF THE INVENTION

In the field of magnetic heads to be mounted on a magnetic recording device such as a hard disk drive (HDD), recently, the recording method has been moving from a longitudinal recording method to a perpendicular recording method in order to improve recording density with respect to a magnetic recording medium such as a hard disk. The perpendicular recording method provides not only a high linear recording density but also an advantage that the recording medium after recording is less influenced by thermal fluctuation.

When the driving method is a rotary actuator, usually, magnetic heads of the perpendicular recording method are formed such that the recording-medium-facing surface of a main magnetic pole is of an inverted trapezoidal shape so as to avoid the problem of side erase. The side erase means that the skew angle between the central axis of the magnetic head and the tangent to the track of a magnetic disk being the recording medium becomes large at inner and outer radii of the magnetic disk, and as a result, a part of the main magnetic pole at the leading side sticks out to an adjacent track, thereby erasing the information recorded on the track.

The recording-medium-facing surface of the main magnetic pole is of an inverted trapezoidal shape with a longer side on the trailing side and a shorter side on the leading side, wherein the longer side is defined as a track width of the main magnetic pole. Accordingly, when forming an ultra narrow track width, i.e., a track width of 0.2 μm or less, the accuracy of the bevel angle of the inverted trapezoidal shape greatly affects the avoidance of the above-described side erase. Thus, when manufacturing the magnetic head, it is important to form the bevel angle with high accuracy.

In general, there has been known a manufacturing method in which the track width of the main magnetic pole is determined by forming a mask perpendicular to the surface of a magnetic layer and the main magnetic pole is formed by performing dry etching with ion milling. However, the dry etching process with ion milling, which generally requires a plurality of times of angle change of ion beam, tends to become a lengthy treatment, so that it has been difficult to improve the dimensional accuracy.

On the other hand, for example, Japanese Unexamined Patent Application Publication No. 2006-302421 discloses a manufacturing method in which a foundation layer with a higher milling rate than the magnetic layer is formed beneath the magnetic layer and the main magnetic pole is formed in a short time by utilizing the difference in rate. However, since this manufacturing method also requires the angle change of ion milling and additionally requires the step of forming the foundation layer, there cannot be expected an efficient decrease in the milling time and the number of processing steps.

### SUMMARY OF THE INVENTION

It is an object of the present invention to provide a method for manufacturing a perpendicular recording magnetic head, which enables high accuracy formation of a bevel angle of a main magnetic pole in a short time.

In order to achieve the above object, the method for manufacturing a perpendicular recording magnetic head according to the present invention includes the following first to third steps.

At the first step, a main magnetic pole layer is formed on a foundation layer. At the second step, a main magnetic pole forming mask whose recording-medium-facing surface is of an inverted trapezoidal shape is formed on the main magnetic pole layer. At the third step, a main magnetic pole whose recording-medium-facing surface is of an inverted trapezoidal shape is formed by performing ion milling on a laminated structure including the foundation layer and the main magnetic pole layer from a direction which makes a given angle with a lamination direction according to a bevel angle of the inverted trapezoidal shape.

According to the above manufacturing method, since the recording-medium-facing surface of the main magnetic pole forming mask formed at the second step is of an inverted trapezoidal shape, when ion milling is performed at an appropriate angle according to its bevel angle at the third step, the bevel angle of the recording-medium-facing surface of the main magnetic pole forming mask can be transferred to a bevel angle of the recording-medium-facing surface of the main magnetic pole. Thus, the bevel angle of the recording-medium-facing surface of the main magnetic pole can be formed with high accuracy.

In addition, since the ion milling can be performed without changing the angle at the third step, the main magnetic pole can be formed in a shorter time than before.

The other objects, constructions and advantages of the present invention will be further detailed below with reference to the attached drawings. However, the attached drawings show only illustrative examples.

### BRIEF DESCRIPTION OF THE DRAWINGS

FIG. 1 is a perspective view of a magnetic head to which a method for manufacturing a perpendicular recording magnetic head according to the present invention is applicable;

FIG. 2 is a plan view schematically showing a portion of a perpendicular recording head contained in the magnetic head shown in FIG. 1;

FIG. 3 is a sectional view taken along line 3-3 of FIG. 2;

FIG. 4 is a sectional view taken along line 4-4 of FIG. 2;

FIG. 5 is a diagram showing a manufacturing step of a method for manufacturing a perpendicular recording magnetic head according to the present invention;

FIG. 6 is a diagram showing a step after the step shown in FIG. 5;

FIG. 7 is a diagram showing a step after the step shown in FIG. 6;

FIG. 8 is a diagram showing a step after the step shown in FIG. 7;

FIG. 9 is a diagram showing a step after the step shown in FIG. 8;

FIG. 10 is a diagram showing a step after the step shown in FIG. 9;

FIG. 11 is a diagram showing a step after the step shown in FIG. 10; and

FIG. 12 is a diagram showing a step after the step shown in FIG. 11.

### DESCRIPTION OF THE PREFERRED EMBODIMENTS

At first, the structure of a magnetic head that will be manufactured according to a method for manufacturing a perpendicular recording magnetic head according to the present invention will be described, and then, the method for manufacturing a perpendicular recording magnetic head according to the present invention will be described.

### 1. Magnetic Head

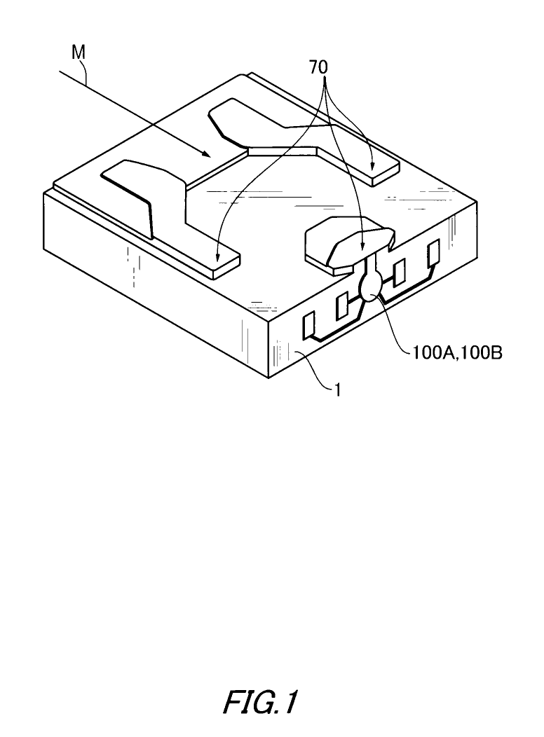

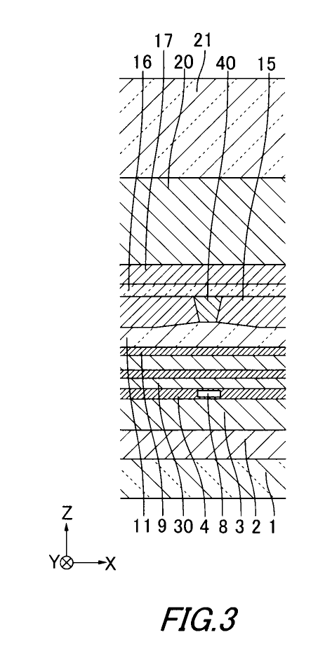

FIGS. 1 to 4 show a magnetic head to be used in combination with a rapidly spinning magnetic recording medium such as a hard disk. Magnetic heads of this type are generally called “floating-type”.

Referring first to FIG. 1, the magnetic head has a slider substrate 1 of a generally rectangular prism structure. The slider substrate 1 has an air bearing surface 70 directly related to the floating characteristics, and a recording/reproducing head (100A, 100B) is disposed at a side end face located on the side of an air flow-out end (trailing edge) with respect to an air flow direction M.

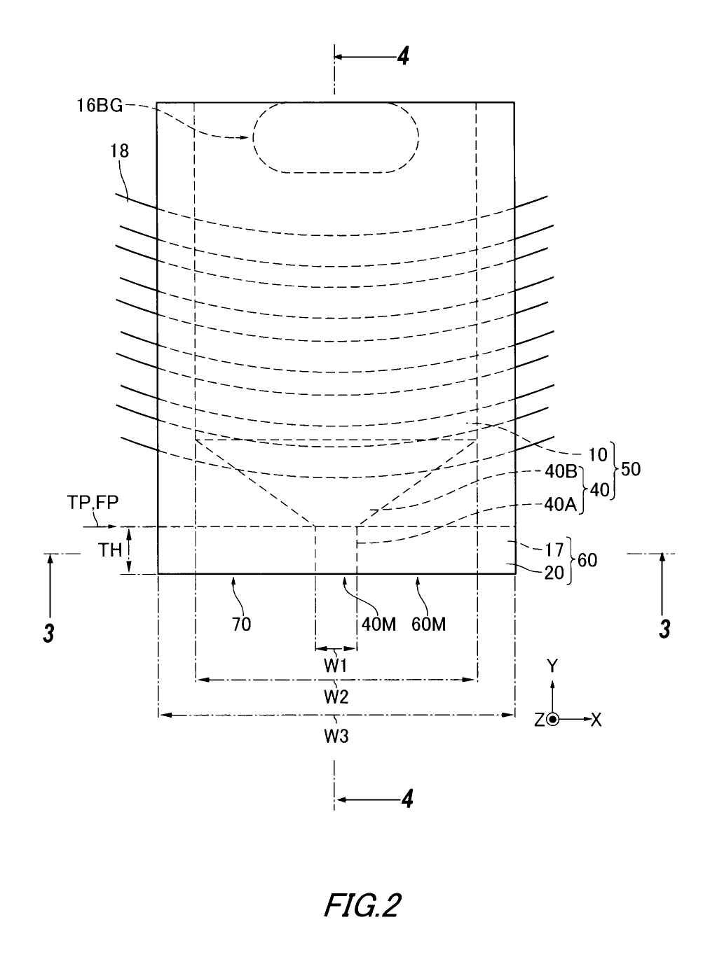

Details of the recording/reproducing head (100A, 100B) are shown in FIGS. 2 to 4. In FIGS. 2 to 4, dimensions along X, Y and Z axes are called “width”, “length” and “thickness/height”, respectively. Along the Y axis, moreover, sides close to and remote from the air bearing surface 70 are designated by “front” and “rear”, respectively, and being positioned forward and being positioned rearward are expressed by “project” and “recede”, respectively.

The magnetic head shown in FIGS. 2 to 4 is a complex-type head which can perform both recording and reproducing. In the magnetic head, an insulating film 2, the reproducing head 100A using magneto-resistive effect (MR), a separating film 9, the recording head 100B for performing a recording process in a perpendicular recording method, and an overcoat film 21 are layered on the slider substrate 1 in the mentioned order.

The reproducing head 100A is formed, for example, by layering a lower read shield film 3, a shield gap film 4, and an upper read shield film 30 in the mentioned order. In the shield gap film 4, a reproducing head (or MR element 8) is embedded in such a manner as to be exposed on the air bearing surface 70. The air bearing surface 70 is uniquely defined with reference to one end face of the slider substrate 1 supporting a series of components from the insulating film 2 to the overcoat film 21, more specifically, refers to a surface containing one end face of the slider substrate 1.

Both the lower read shield film 3 and the upper read shield film 30 function to magnetically separate the MR element 8 from the surroundings and extend rearward from the air bearing surface 70. The lower read shield film 3 is made of, for example, a magnetic material such as a nickel-iron alloy (NiFe). The upper read shield film 30 is formed, for example, by layering two upper read shield film portions 5, 7 with a non-magnetic film 6 interposed therebetween. Both the upper read shield film portions 5, 7 are made of, for example, a magnetic material such as a nickel-iron alloy. The non-magnetic film 6 is made of, for example, a non-magnetic material such as ruthenium (Ru) or alumina. The upper read shield film 30 is not necessarily required to have a layered structure but may have a single-layer structure of a magnetic material.

The shield gap film 4 functions to electrically separate the MR element 8 from the surroundings and is made of, for example, a non-magnetic insulating material such as alumina. The MR element 8 is for making use of giant magneto-resistive effect (GMR) or tunneling magneto-resistive effect (TMR), for example.

The recording head 100B is a so-called shield-type perpendicular recording head including a first non-magnetic film 11, a second non-magnetic film 15, a magnetic pole film 50, a gap film 16 with an opening (or back gap 16BG) for magnetic connection, a coil film 18 embedded in an insulating film 19, and a magnetic film 60.

The magnetic pole film 50 extends rearward from the air bearing surface 70 and includes an auxiliary magnetic pole film 10 and a main magnetic pole 40.

The auxiliary magnetic pole film 10 extends from behind the air bearing surface 70 to the back gap 16BG. For example, the auxiliary magnetic pole film 10 is disposed on the leading side of the main magnetic pole 40 and has a rectangular plan shape (width W2), as shown in FIG. 2. It should be noted that the auxiliary magnetic pole film 10 may be disposed on the trailing side of the main magnetic pole 40.

The first non-magnetic film 11 functions to electrically and magnetically separate the auxiliary magnetic pole film 10 from the surroundings and is made of, for example, a non-magnetic insulating material such as alumina.

The second non-magnetic film 15 functions to electrically and magnetically separate the main magnetic pole 40 from the surroundings and is made of, for example, a non-magnetic insulating material such as alumina.

The main magnetic pole 40 extends from the air bearing surface 70 to the back gap 16BG. The main magnetic pole 40 is a multilayered film and disposed inside the second non-magnetic film 15, and its recording-medium-facing surface 40M (see FIG. 2) is of an inverted trapezoidal shape, whose upper bottom and lower bottom are the longer side on the trailing side and the shorter side on the leading side, respectively. The upper side of the inverted trapezoidal shape is a substantial recording portion of the main magnetic pole 40, and its width W1 defines the recording track width and is approximately 0.2 μm or less. In addition, the bevel angle of the inverted trapezoidal shape (i.e., the angle between a lateral side of the trapezoidal shape and a line perpendicular to the upper and lower sides) is appropriately set so as to avoid side erase in consideration of the above-mentioned skew angle.

The main magnetic pole 40 includes, for example, a small width portion 40A extending rearward from the air bearing surface 70 and a large width portion 40B connected to the rear of the small width portion 40A, as shown in FIG. 2.

The small width portion 40A is a substantial magnetic flux emitting portion (so-called magnetic pole film) and has a constant width W1. The large width portion 40B is a portion intended to supply a magnetic flux to the small width portion 40A and has a width W2 larger than the width W1. The width of the large width portion 40B decreases in its front portion toward the small width portion 40A. The position where the width of the main magnetic pole 40 starts to increase from the width W1 to the width W2 is a so-called flare point FP.

The gap film 16 is a gap for magnetically separating the magnetic pole film 50 and the magnetic film 60 and is made of, for example, a non-magnetic insulating material such as alumina or a non-magnetic conductive material such as ruthenium. The thickness of the gap film 16 is approximately 0.01 to 0.1 μm.

The coil film 18 functions to generate a magnetic flux and is made of, for example, a highly conductive material such as copper (Cu). The coil film 18 is wound around the back gap 16BG to have a winding structure (or spiral structure), as shown in FIG. 2.

The insulating film 19 functions to electrically separate the coil film 18 from the surroundings and is made of, for example, a non-magnetic insulating material such as a photoresist or a spin on glass (SOG) which becomes liquid when heated. The forefront position of the insulating film 19 is a throat height zero position TP, and the distance between the throat height zero position TP and the air bearing surface 70 is a so-called “throat height TH”. FIG. 2 shows a case where the throat height zero position TP matches the flare point FP.

The magnetic film 60 functions to absorb a spreading component of a magnetic flux emitted from the magnetic pole film 50 so as to increase the gradient of the perpendicular magnetic field and also absorb a magnetic flux returning from a recording medium so as to circulate the magnetic flux between the recording head 100B and a recording medium. The magnetic film 60, which extends rearward from the air bearing surface 70 on the trailing side of the magnetic pole film 50, is separated from the magnetic pole film 50 by the gap film 16 at its front but connected to the magnetic pole film 50 through the back gap 16BG at its rear. An end face 60M of the magnetic film 60 on the side close to the air bearing surface 70 is, for example, of a rectangular shape having a width W3 larger than the width W1, as shown in FIG. 2. The magnetic film 60 includes, for example, a write shield film 17 and a return yoke film 20 which are distinct from each other.

The write shield film 17 functions to mainly increase the gradient of the perpendicular magnetic field and is made of, for example, a high-saturation-magnetic-flux-density magnetic material such as a nickel-iron alloy or an iron-based alloy. Particularly by absorbing a spreading component of a magnetic flux emitted from the magnetic pole film 50, the write shield film 17 functions to: increase the magnetic field gradient of the perpendicular magnetic field; decrease the recording width; and incorporate an oblique magnetic field component into the perpendicular magnetic field. However, the write shield film 17 may additionally function to circulate the magnetic flux like the return yoke film 20. The write shield film 17 is adjacent to the gap film 16 and extends rearward from the air bearing surface 70 to have its rear end adjacent to the insulating film 19. Thus, the write shield film 17 serves to define the forefront position (throat height zero position TP) of the insulating film 19.

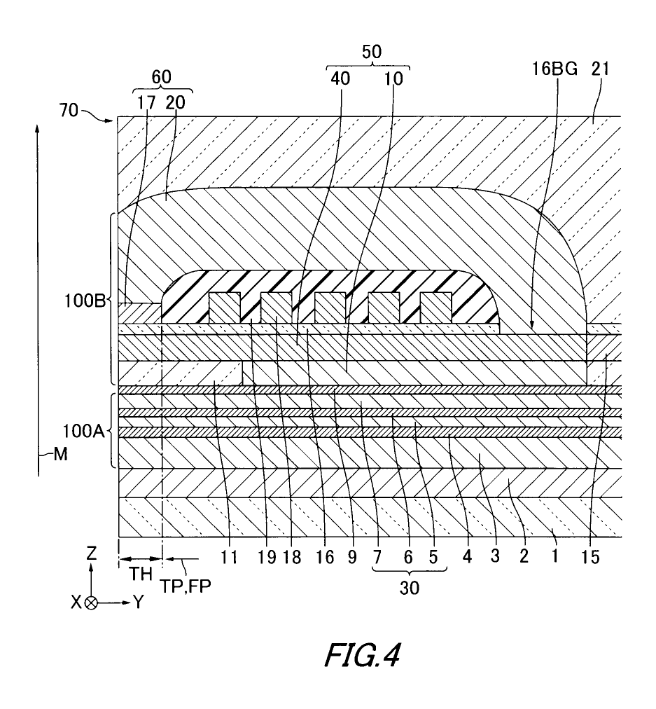

The return yoke film 20 functions to circulate the magnetic flux and is made of, for example, a magnetic material similar to that of the write shield film 17. The return yoke film 20 extends from the air bearing surface 70, through above the insulating film 19, to the back gap 16BG on the trailing side of the write shield film 17 and is connected to the write shield film 17 at its front but to the magnetic pole film 50 at its rear through the back gap 16BG, as shown in FIG. 4.

The overcoat film 21 functions to protect the magnetic head and is made of, for example, a non-magnetic insulating material such as alumina.

### 2. Method for Manufacturing a Perpendicular Recording Magnetic Head

Next will be described a method for manufacturing a perpendicular recording magnetic head according to the present invention with reference to FIGS. 5 to 12. FIGS. 5 to 12 show how the recording-medium-facing surface 40M (see FIG. 2) will be at individual manufacturing steps.

The processes before the production process of the perpendicular recording magnetic head have been known heretofore and do not require specific description. Roughly speaking, it can be manufactured by layering a series of components in order by using a conventional thin-film process including a film formation technique such as plating or sputtering, a patterning technique such as photolithography, an etching technique such as dry etching or wet etching, and a polishing technique such as CMP (chemical mechanical polishing).

Roughly speaking the thin-film process with reference to FIGS. 1 to 4, when manufacturing the magnetic head, at first, the insulating film 2 is formed on the slider substrate 1, and then the lower read shield film 3, the shield gap film 4 embedded with the MR element 8, and the upper read shield film 30 (the upper read shield film portions 5, 7 and the non-magnetic film 6) are layered on the insulating film 2 in the mentioned order, thereby forming the reproducing head 100A.

Then, after the separating film 9 is formed on the reproducing head 100A, the magnetic pole film 50 (the auxiliary magnetic pole film 10 and the main magnetic pole 40) enclosed with the first non-magnetic films 11, 15, the gap film 16, the coil film 18 enclosed with the insulating film 19, and the magnetic film 60 (the write shield film 17 and the return yoke film 20) are layered on the separating film 9 in the mentioned order, thereby forming the recording head 100B. Finally, after the overcoat film 21 is formed on the recording head 100B, the air bearing surface 70 is formed by using a machining process or a polishing process, thereby completing the magnetic head.

In the above described production processes of a magnetic head, the method for manufacturing a perpendicular recording head according to the present invention is concerned with a process of forming the main magnetic pole 40. Hereinafter, the description will be made with reference to FIGS. 5 to 12.

As shown in FIG. 5, a first non-magnetic film 11 as a foundation layer is formed by sputtering alumina or the like on the previously formed separating film 9, and a main magnetic pole layer 12 is formed on the foundation layer. At this time, although plating is acceptable, it is preferred to form the main magnetic pole layer 12 with magnetic and non-magnetic films alternately deposited by a dry process such as a sputtering process. Here, the materials of the respective magnetic and non-magnetic films may be suitably selected depending on the settings.

With the main magnetic pole layer 12 being thus formed, when no current flows through the coil film 18, the magnetic film becomes antiferromagnetic through the non-magnetic film, so that the magnetic field is offset to suppress the leakage magnetic flux, which results in preventing the so-called pole erase phenomenon where information recorded on a magnetic recording medium is erased at the time other than recording.

When current flows through the coil film 18, on the other hand, it becomes ferromagnetic because of the magnetic field generated from the coil film 18, so that information can be appropriately recorded on a magnetic recording medium.

However, needless to say, the main magnetic pole film 12 is not limited to the above layer configuration, but there may be suitably adopted a structure formed by depositing magnetic films of the same material, a structure formed by alternately depositing magnetic films of different materials, a structure of a single-layer magnetic film, or the like.

Next, a main magnetic pole forming mask whose recording-medium-facing surface is of an inverted trapezoidal shape is formed on the main magnetic pole film 12. The main magnetic pole forming mask determines the track width W1 and the bevel angle of the main magnetic pole 40.

At first, after a resist is applied on the main magnetic pole film 12 to form a resist film, a resist pattern 91 that has a groove D coinciding in shape with the main magnetic pole forming mask is formed by photolithography, as shown in FIG. 6.

In a section parallel to the recording-medium-facing surface, the groove D is of an inverted trapezoidal shape, where the length H1 of the lower side at the leading side<the length H2 of the upper side at the tracking side. The length H1 of the lower side coincides with the track width W1 of the main magnetic pole 40, and the main magnetic pole film 12 is exposed at the bottom of the groove D.

When forming the resist pattern 91, moreover, it is formed such that the section of the groove D is of an inverted trapezoidal shape with a given bevel angle θ. The bevel angle θ, which is to be transferred to the main magnetic pole film 12 at the time of ion milling that will be described later, is set depending on the desired bevel angle of the main magnetic pole 40.

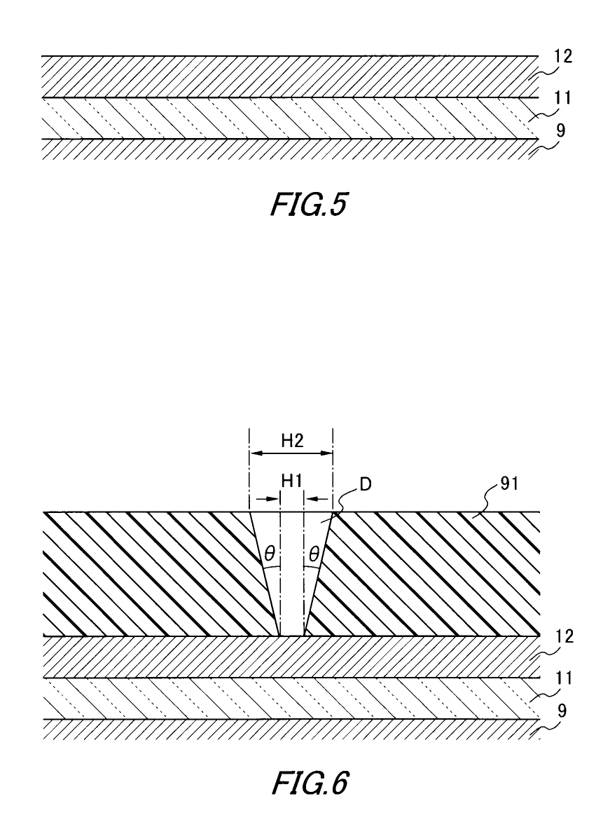

Thereafter, as shown in FIG. 7, a mask layer 13 is formed to fill the groove D such as by sputtering. At this time, it is preferred that the mask layer 13 is formed using a material highly resistant to dry etching, such as alumina.

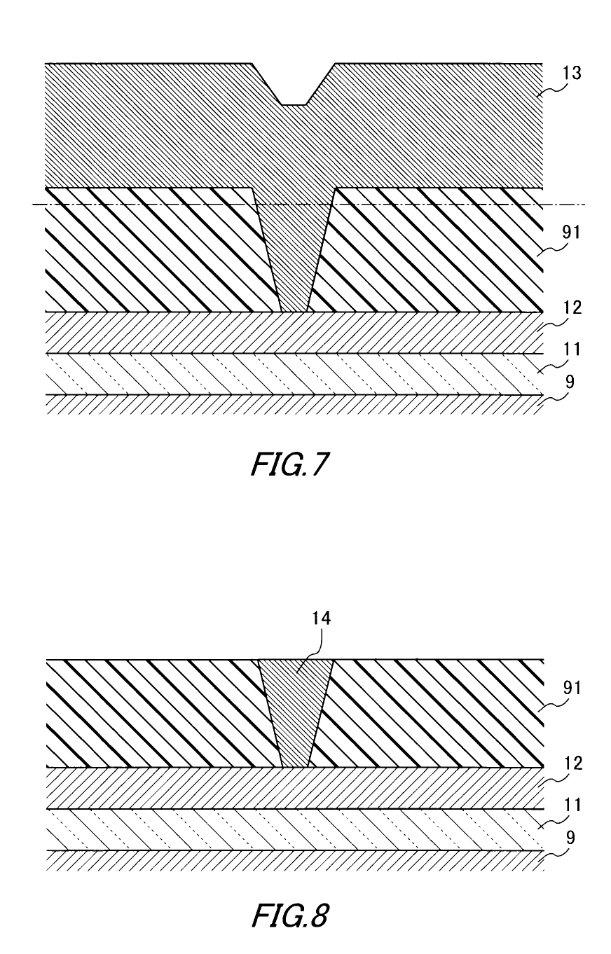

Then, the surface is polished such as by CMP until the resist pattern 91 will be exposed (see the dashed-dotted line of FIG. 7), as shown in FIG. 8, and finally, the resist pattern 91 is removed using a remover or the like, thereby forming a main magnetic pole forming mask 14. The recording-medium-facing surface of the main magnetic pole forming mask 14 is of an inverted trapezoidal shape with the length H1 at its lower side and the bevel angle θ.

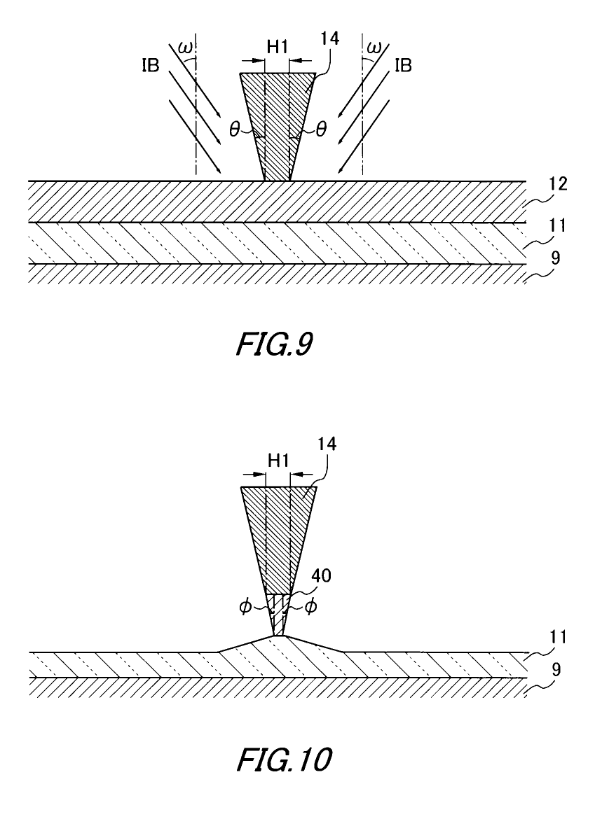

Subsequently, ion milling is performed on the laminated structure including the foundation layer and the main magnetic pole layer 12 from a direction which makes a given angle ω with the lamination direction according to the bevel angle θ of the inverted trapezoidal shape, as shown in FIG. 9, thereby forming the main magnetic pole 40 whose recording-medium-facing surface is of an inverted trapezoidal shape, as shown in FIG. 10.

Ion milling is performed by applying ion beams IB at a given angle ω for dry etching while oscillating the substrate. At this time, since the recording-medium-facing surface of the main magnetic pole forming mask 14 is of an inverted trapezoidal shape, milling rate in the main magnetic pole layer 12 beneath the main magnetic pole forming mask 14 varies along the direction perpendicular to the lamination direction because of the inclination of the lateral sides of the inverted trapezoidal shape. More specifically, the tendency of re-adhesion of shavings due to etching increases toward the top of the main magnetic pole layer 12 (i.e., the main magnetic pole forming mask 14), so that the milling rate increases from the top to the bottom of the main magnetic pole layer 12, following the above inclination. By selecting an appropriate irradiation angle ω, accordingly, the bevel angle θ of the main magnetic pole forming mask 14 can be transferred to a bevel angle φ of the main magnetic pole 40.

Moreover, the length H1 at the lower side of the main magnetic pole forming mask 14 is also transferred to the upper side of the main magnetic pole 40, thereby determining the tracking width W1 of the main magnetic pole 40. It should be noted that although FIG. 9 shows only the small width portion 40A, which is selected from the large width portion 40B and the small width portion 40A of the main magnetic pole 40 because of its importance for magnetic recording, the large width portion 40B is simultaneously dry etched by the ion beams IB.

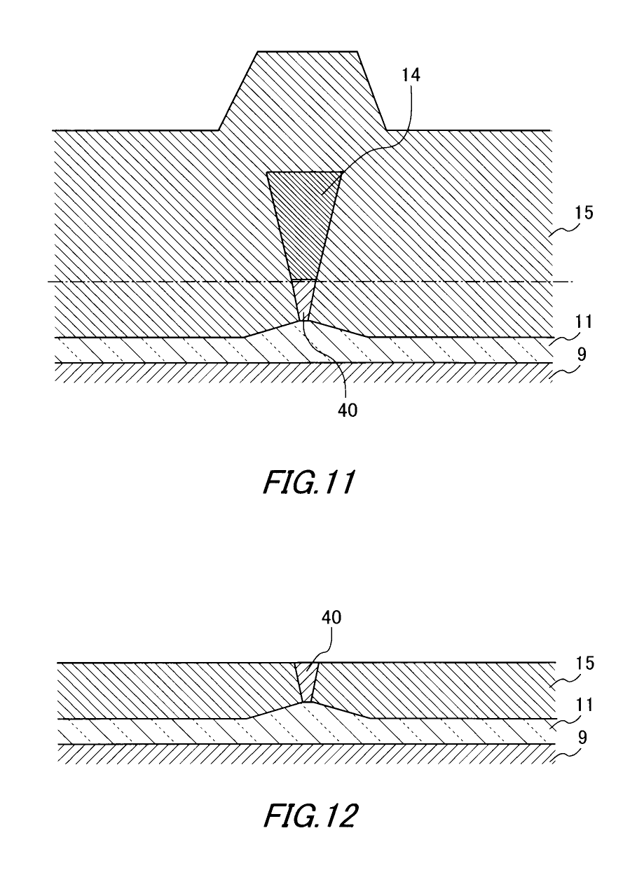

Then, an insulating film 15 is formed such as by sputtering, as shown in FIG. 11, thereby covering the main magnetic pole 40 with the insulating film 15. Thereafter, the surface of the insulating film 15 and the main magnetic pole 40 (see the dashed-dotted line of FIG. 11) is flattened by CMP, as shown in FIG. 12. After this, necessary post-processes are performed to obtain the intended thin-film magnetic head.

According to the above manufacturing method, since the recording-medium-facing surface of the main magnetic pole forming mask 14 is of an inverted trapezoidal shape, when ion milling is performed at an angle ω according to its bevel angle θ, the bevel angle θ of the recording-medium-facing surface of the main magnetic pole forming mask 14 can be transferred to a bevel angle φ of the recording-medium-facing surface of the main magnetic pole 40. Thus, the bevel angle φ of the recording-medium-facing surface of the main magnetic pole 40 can be formed with high accuracy.

According to the experiment carried out by the inventors, for instance, when the bevel angle θ of the main magnetic pole forming mask 14 was 5 degrees, the irradiation angle ω of ion milling was set to 30 degrees, where the obtained bevel angle φ of the main magnetic pole 40 was 9 degrees. On the other hand, when the bevel angle θ of the main magnetic pole forming mask 14 was 8.5 degrees, the irradiation angle ω of ion milling was set to 35 degrees, where the obtained bevel angle φ of the main magnetic pole 40 was 12 degrees.

In addition, since the ion milling can be performed without changing the angle, the main magnetic pole 40 can be formed in a shorter time than before. This is because the milling rate in the main magnetic pole layer 12 can be varied to have a desired bevel angle φ by selecting an appropriate irradiation angle ω, as described above. According to the experiment carried out by the inventors, the time was reduced by about 20% of the conventional one. With this, the dimensional accuracy was also improved by about 20%.

The present invention has been described in detail above with reference to preferred embodiments. However, obviously those skilled in the art could easily devise various modifications of the invention based on the technical concepts underlying the invention and teachings disclosed herein.

What is claimed is:

1. A method for manufacturing a perpendicular recording magnetic head comprising:
a first step of forming a main magnetic pole layer on a foundation layer;
a second step of forming, on said main magnetic pole layer, a main magnetic pole forming mask whose recording-medium-facing surface is of an inverted trapezoidal shape; and
a third step of forming a main magnetic pole whose recording-medium-facing surface is of an inverted trapezoidal shape by performing ion milling on a laminated structure including said foundation layer and said main magnetic pole layer from a direction which makes a given angle with a lamination direction according to a bevel angle of said inverted trapezoidal shape.

2. The method for manufacturing a perpendicular recording magnetic head as claimed in claim 1, wherein at said first step, said main magnetic pole film is formed by a dry process.

3. The method for manufacturing a perpendicular recording magnetic head as claimed in claim 1, wherein at said second step, said main magnetic pole forming mask is formed such that after a resist pattern that has a groove coinciding in shape with said main magnetic pole forming mask is formed on said main magnetic pole layer by photolithography, a mask layer is formed to fill said groove and then said resist pattern is removed.

4. The method for manufacturing a perpendicular recording magnetic head as claimed in claim 1, wherein said main magnetic pole forming mask is made of alumina.
